(19) United States
(12) Patent Application Publication
(10) Pub. No.: US 2025/0013098 A1
(43) Pub. Date: Jan. 9, 2025

(54) DISPLAY DEVICE

(71) Applicant: Japan Display Inc., Tokyo (JP)

(72) Inventors: Tenfu NAKAMURA, Tokyo (JP); Keiji TAGO, Tokyo (JP); Yoshinori TANAKA, Tokyo (JP)

(73) Assignee: Japan Display Inc., Tokyo (JP)

(21) Appl. No.: 18/761,325

(22) Filed: Jul. 2, 2024

(30) Foreign Application Priority Data
Jul. 6, 2023 (JP) 2023-111503

(51) Int. Cl. G02F 1/13357; G02F 1/1362

(52) U.S. Cl. CPC G02F 1/133605; G02F 1/133615; G02F 1/136286; G02F 2201/123

(57) ABSTRACT

According to one embodiment, the transparent layer has a plurality of band portions, each of which has a triangular shape with a first edge, second edge and third edge, the first edge is shorter than the second edge and third edge, the second edge is shorter than the edge side, the first edge extends along the first direction, a direction of extension of an imaginary line connecting a first point at a center of the first edge and a second point where the second and third edges intersect is a direction of extension of each of the band portions, the direction of extension is tilted at 4° to the second direction, and a length of the first edge is shorter than an interval between each adjacent pair of the signal lines.

### CROSS-REFERENCE TO RELATED APPLICATIONS

This application is based upon and claims the benefit of priority from Japanese Patent Application No. 2023-111503, filed Jul. 6, 2023, the entire contents of which are incorporated herein by reference.

### FIELD

Embodiments described herein relate generally to a display device.

### BACKGROUND

Display devices that can switch between a scattering state, in which incident light is scattered, and a transmission state, in which incident light is transmitted, using polymer dispersed liquid crystal (PDLC) have been proposed. For transparent display devices using PDLC, an edge light mode is adopted, in which a light source is disposed in an end portion of the light guide. However, when the edge light mode is used for PDLC display devices, there is conventionally a drawback that the brightness of the display surface decreases as the distance from the light source increases.

As a solution to such a drawback, such display devices have been developed in which a light guide element including a transparent layer having a low refractive index, formed in a shape of an isosceles triangle is provided on the liquid crystal panel.

However, these display devices entail a new drawback that moiré may occur between the isosceles triangle-shaped transparent layer and pixels.

### BRIEF DESCRIPTION OF THE DRAWINGS

FIG. 1 is a plan view schematically showing a configuration of a display device of an embodiment.

FIG. 2 is a cross-sectional view schematically showing a configuration of a display panel shown in FIG. 1.

FIG. 3 is an exploded perspective view showing a main part of the display device.

FIG. 4 is a cross-sectional view schematically showing a configuration example of the display device.

FIG. 5 is a plan view schematically showing a configuration example of a light guide element.

FIG. 6 is a plan view schematically showing another configuration example of the light guide element.

FIG. 7 illustrates a simulation result of intensity and pitch of moiré when the pitch of band portions is varied.

FIG. 8 is a diagram illustrating that moiré does not occur when a direction of extension of the band portions is tilted.

FIG. 9 is a diagram illustrating that moiré occurs when the direction of extension of the band portions is not tilted.

FIG. 10 illustrates a simulation result of how moiré occurs when the pitch of band portions is varied and the direction of extension of the band portions is changed.

FIG. 11 illustrates another simulation result of how moiré occurs when the pitch of band portions is varied and the direction of extension of the band portions is changed.

FIG. 12 illustrates still another simulation result of how moiré occurs when the pitch of band portions is varied and the direction of extension of the band portions is changed.

FIG. 13 illustrates still another simulation result of how moiré occurs when the pitch of band portions is varied and the direction of extension of the band portions is changed.

### DETAILED DESCRIPTION

In general, according to one embodiment, a display device comprises
a display panel comprising a first substrate, a second substrate, a liquid crystal layer containing a polymer dispersed liquid crystal;
a plurality of light emitting elements; and
a light guide element,
the first substrate comprising:
a first base;
a plurality of scanning lines provided on the first base, extending along a first direction and arranged along a second direction intersecting the first direction;
a plurality of signal lines provided on the first base, extend along the second direction, and arranged along the first direction;
a plurality of switching elements electrically connected to the plurality of scanning lines and the plurality of signal lines; and
a plurality of pixel electrodes electrically connected to the plurality of switching elements, respectively,
the second substrate comprising:
a second base; and
a common electrode opposing the plurality of pixel electrodes,
the light guide element comprising:
a third base; and
a transparent layer having a refractive index lower than a refractive index of the third base, wherein
the transparent layer includes a plurality of band portions arranged along the first direction,
each of the plurality of band portions includes a triangular shape having a first edge, a second edge, and a third edge,
the first side is shorter than the second edge and the third edge,
the second edge is shorter than the third edge,
the first edge extends along the first direction,
a direction of extension of an imaginary line connecting a first point at a center of the first edge and a second point at which the second edge and the third edge intersect each other is set to a direction of extension of each of the plurality of band portions,
the direction of extension is tilted at an angle of 4° with respect to the second direction, and
a length of the first edge is shorter than an interval between each adjacent pair of the plurality of signal lines.

An object of this embodiment is to suppress deterioration in display quality.

Embodiments will be described hereinafter with reference to the accompanying drawings. Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

The embodiments described herein are not general ones, but rather embodiments that illustrate the same or corresponding special technical features of the invention. The following is a detailed description of one embodiment of a display device with reference to the drawings.

In this embodiment, a first direction X, a second direction Y and a third direction Z are orthogonal to each other, but may intersect at an angle other than 90°. The direction toward the tip of the arrow in the third direction Z is defined as up or above, and the direction opposite to the direction toward the tip of the arrow in the third direction Z is defined as down or below. Note that the first direction X, the second direction Y and the third direction Z may as well be referred to as an X direction, a Y direction and a Z direction, respectively.

With such expressions as “the second member above the first member” and “the second member below the first member”, the second member may be in contact with the first member or may be located away from the first member. In the latter case, a third member may be interposed between the first member and the second member. On the other hand, with such expressions as “the second member on the first member” and “the second member beneath the first member”, the second member is in contact with the first member.

Further, it is assumed that there is an observation position to observe the optical control element on a tip side of the arrow in the third direction Z. Here, viewing from this observation position toward the X-Y plane defined by the first direction X and the second direction Y is referred to as plan view. Viewing a cross-section of the display device in the X-Z plane defined by the first direction X and the third direction Z or in the Y-Z plane defined by the second direction Y and the third direction Z is referred to as cross-sectional view.

### Embodiment

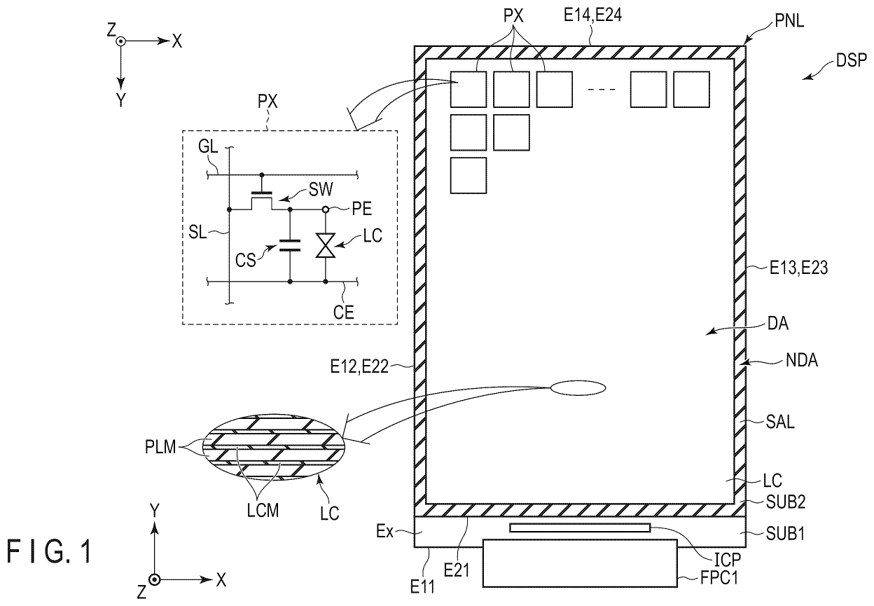

FIG. 1 is a plan view schematically showing a configuration of a display device of an embodiment.

In this embodiment, as an example of a display device DSP, a liquid crystal display device in which polymer dispersed liquid crystal is applied will be described. The display device DSP comprises a display panel PNL, an IC chip ICP, and a wiring board FPC1.

The display panel PNL comprises a substrate SUB1, a substrate SUB2, a liquid crystal layer LC, and a seal SAL. The substrate SUB1 and the substrate SUB2 are each formed into a flat plate parallel to the X-Y plane. The substrate SUB1 and the substrates SUB2 overlap each other in plan view. The substrate SUB1 and the substrate SUB2 are attached together by a seal SAL. The liquid crystal layer LC is held between the substrate SUB1 and the substrate SUB2 and sealed therein by the seal SAL.

As shown schematically in enlarged form in FIG. 1, the liquid crystal layer LC comprises polymer dispersed liquid crystal containing polymers PLM and liquid crystal molecules LCM. For example, the polymers PLM are liquid crystalline polymers. The polymers PLM are formed in a stripe shape extending along the first direction X. The liquid crystal molecules LCM are dispersed in gaps between the polymers PLM and are aligned such that their longitudinal axes are along the first direction X. Each of the polymers PLM and the liquid crystal molecules LCM has an optical anisotropy or refractive index anisotropy. The responsivity of the polymers PLM to an electric field is lower than that of the liquid crystal molecules LCM to the electric field.

For example, the alignment direction of the polymers PLM does not substantially changes regardless of the presence/absence of an electric field. On the other hand, the alignment direction of the liquid crystal molecules LCM changes in response to an electric field when a voltage higher than or equal to the threshold is being applied to the liquid crystal layer LC. When no voltage is being applied to the liquid crystal layer LC, the respective optical axes of the polymers PLM and the liquid crystal molecules LCM are parallel to each other, and light entering the liquid crystal layer LC is transmitted therethrough (transparent state) without being substantially scattered in the liquid crystal layer LC. When voltage is being applied to the liquid crystal layer LC, the respective optical axes of the polymers PLM and the liquid crystal molecules LCM cross each other, and light entering the liquid crystal layer LC is scattered within the liquid crystal layer LC (scattered state).

The display panel PNL comprises a display area DA for displaying images and a frame-like non-display area NDA surrounding the display area DA. The seal SAL is located in the non-display area NDA. The display area DA comprises pixels PX arranged in a matrix along the first direction X and the second direction Y.

As shown enlarged in FIG. 1, each of the pixels PX comprises a switching element SW, a pixel electrode PE, a common electrode CE, a liquid crystal layer LC, and the like. The switching element SW is constituted by a thin-film transistor (TFT), for example, and is electrically connected to a respective scanning line GL and a respective signal line SL.

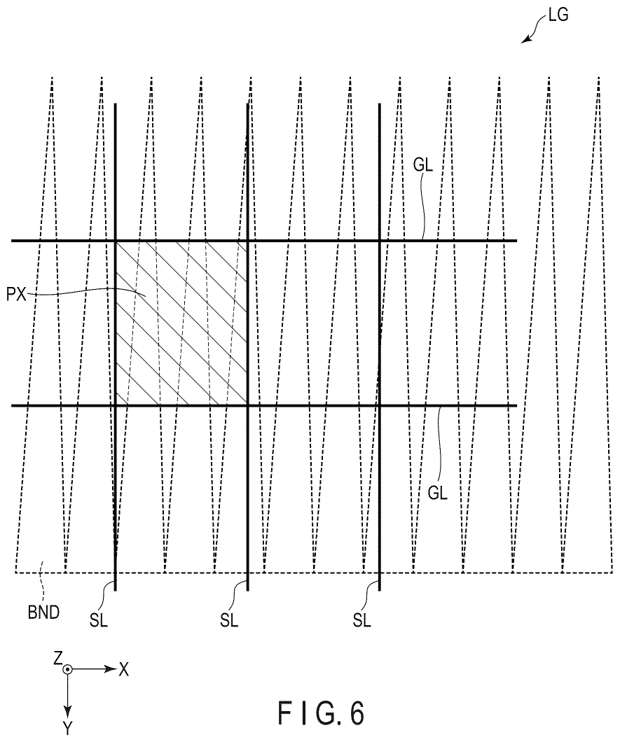

A plurality of scanning lines GL extended along the first direction X and arranged side by side along the second direction Y (see FIG. 6, which will be described later). One scanning line GL is electrically connected to the switching element SW in each of the pixels PX aligned along the first direction X.

A plurality of signal lines SL extend along a direction parallel to the second direction Y and are arranged side by side along the first direction X (see FIG. 6, which will be described later). One signal line SL is electrically connected to the switching element SW in each of the pixels PX aligned along the second direction Y. The signal lines SL intersect the scanning lines GL.

As shown in FIG. 1 and FIG. 6, which will be described later, each of the pixels PX occupies the area partitioned by a respective adjacent pair of signal lines SL and a respective adjacent pair of scanning lines GL. That is, the plurality of pixels PX are arranged at a predetermined pitch along each of the first direction X and the second direction Y. The pitch of the pixels PX arranged along the first direction X is equal to the pitch of the signal lines SL. The pitch of the pixels PX arranged along the second direction Y is equal to the pitch of the scanning lines GL.

The pixel electrodes PE are electrically connected to the switching elements SW, respectively. Each of the pixel electrodes PE opposes the common electrode CE, and the liquid crystal layer LC (in particular, liquid crystal molecules LCM) is driven by the electric field produced between the pixel electrode PE and the common electrode CE.

The scanning lines GL, the signal lines SL, the switching elements SW, and the pixel electrodes PE are provided on the substrate SUB1. A capacitor CS is formed, for example, between an electrode of the same potential as that of the common electrode CE and an electrode of the same potential as that of the respective pixel electrode PE.

The substrate SUB1 includes an end portion E11 and an end portion E14, which extend along the first direction X, and an end portion E12 and an end portion E13, which extend along the second direction Y. The substrate SUB2 includes an end portion E21 and an end portion E24, which extend along the first direction X, and an end portion E22 and an end portion E23, which extend along the second direction Y.

In the example illustrated in FIG. 1, the end portion E12 and the end portion E22 overlap each other in plan view, and so do the end portion E13 and the end portion E23, and the end portion E14 and the end portion E24, but may not be arranged to overlap. The end portion E21 is located between the end portion E11 and the display area DA in plan view. The substrate SUB1 includes an extended region Ex between the end portion E11 and the end portion E21.

The IC chip ICP and the circuit board FPC1 are each connected to the extended region Ex. The IC chip ICP contains, for example, a display driver built therein that outputs signals necessary for image display. The wiring board FPC1 is a flexible printed circuit board that can be bent. Note that the IC chip ICP may be connected to the wiring board FPC1. The IC chip ICP and the wiring board FPC1 read out signals from the display panel PNL in some cases, but function mainly as signal sources that supply signals to the display panel PNL.

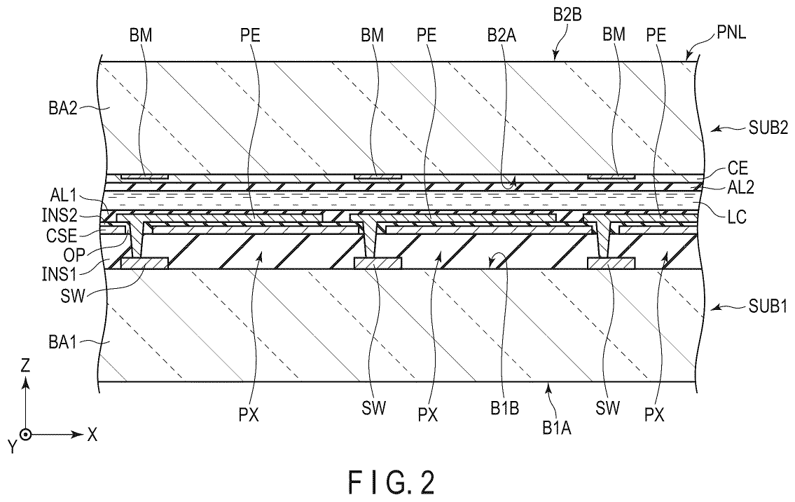

FIG. 2 is a cross-sectional view schematically showing a configuration of the display panel shown in FIG. 1.

The substrate SUB1 comprises a base BA1, an insulating layer INS1, an insulating layer INS2, a capacitive electrode CSE, a switching element SW, a pixel electrode PE, and an alignment film AL1. The substrate SUB1 further comprises the scanning lines GL and signal lines SL shown in FIG. 1.

The base BA1 is formed of a translucent material. The base BA1 comprises a main surface (lower surface) B1A and a main surface (upper surface) B1B on an opposite side to the main surface 10A. The switching elements SW are disposed on the main surface B1B.

The insulating layer INS1 covers the switching elements SW. The capacitive electrode CSE is located between the insulating layer INS1 and the insulating layer INS2. The pixel electrode PE is provided for each pixel PX on the insulating layer INS2. The pixel electrode PE is electrically connected to the switching element SW via an opening OP formed in the capacitive electrode CSE. The pixel electrode PE overlaps the capacitive electrode CSE while interposing the insulating layer INS2 therebetween to form the capacitor CS of the pixel PX. The alignment film AL1 covers the pixel electrode PE.

The substrate SUB2 comprises a base BA2, a light-shielding layer BM, a common electrode CE, and an alignment film AL2.

The base BA2 is formed of a translucent material. The base BA2 comprises a main surface (lower surface) B2A and a main surface (upper surface) B2B on an opposite side to the main surface B2A. The main surface B2A of the base BA2 opposes the main surface B2B of the base BA1. The light-shielding layer BM and the common electrode CE are disposed on the main surface B2A. The light-shielding layer BM is located, for example, directly above the switching element SW and directly above the scanning line GL and the signal line SL, which are not shown in the figure.

The common electrode CE is located over a plurality of pixels PX and directly covers the light-shielding layer BM. The common electrode CE opposes the pixel electrode PE. The common electrode CE is electrically connected to the capacitive electrode CSE and is at the same potential as that of the capacitive electrode CSE. The alignment film AL2 covers the common electrode CE. The liquid crystal layer LC is located between the main surface B1B and the main surface B2A and is in contact with the alignment film AL1 and the alignment film AL2.

The base BA1 and the base BA2 are insulating base materials such as glass or plastic. The main surface B1A, main surface B1B, main surface B2A, and main surface B2B are planes substantially parallel to the X-Y plane.

The insulating layer INS1 is formed of a transparent insulating material such as silicon oxide, silicon nitride, silicon oxynitride, acrylic resin or the like. For example, the insulating layer INS1 includes an inorganic insulating layer and an organic insulating layer. The insulating layer INS2 is an inorganic insulating layer such as of silicon nitride.

The capacitive electrode CSE, the pixel electrode PE, and the common electrode CE are transparent electrodes formed from a transparent conductive material such as indium tin oxide (ITO) or indium zinc oxide (IZO).

The light-shielding layer BM is, for example, a conductive layer having a resistance lower than that of the common electrode CE. For example, the light-shielding layer BM is formed of an opaque metal material such as molybdenum (Mo), aluminum (Al), tungsten (W), titanium (Ti), silver (Ag) or the like.

The alignment film AL1 and the alignment film AL2 are horizontal alignment films having an alignment restriction force that is substantially parallel to the X-Y plane. For example, the alignment film AL1 and the alignment film AL2 are subjected to alignment treatment along the first direction X. The alignment treatment may be a rubbing treatment or a photo-alignment treatment.

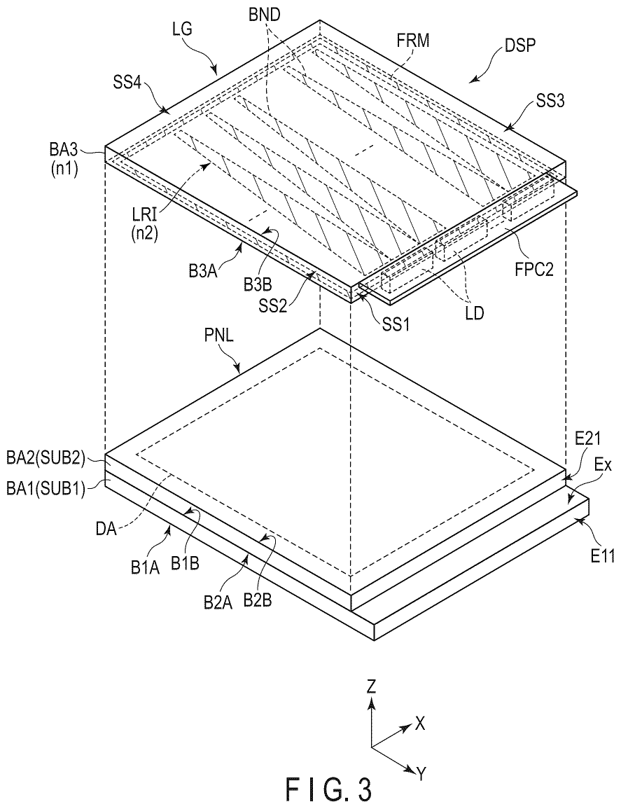

FIG. 3 is an exploded perspective view showing a main part of the display device.

The display device DSP comprises a plurality of light emitting elements LD and a light guiding element LG in addition to the display panel PNL. The substrate SUB1, the substrate SUB2, and the light guiding element LG are arranged side by side in this order along the third direction Z.

The plurality of light emitting elements LD are arranged to be spaced apart from each other along the first direction X. The plurality of light emitting elements LD are connected to the wiring board FPC2. The light emitting elements LD are, for example, light emitting diodes. The light emitting elements LD comprise a red light emitting element, a green light emitting element, and a blue light emitting element, which will not be described in detail though. The light emitted from the light emitting elements LD proceeds along the direction of the arrow indicating the second direction Y.

The light guide element LG comprises a base BA3 and a transparent layer LRI.

The base BA3 is formed of a translucent material. The base BA3 is an insulating base material such as glass or plastic and has a refractive index n1. For example, the base BA3 is a single base material, rather than a plurality of base materials bonded together.

The base BA3 comprises a main surface (lower surface) B3A, a main surface (upper surface) B3B on an opposite side to the main surface B3A, a first side surface SS1, a second side surface SS2, a third side surface SS3, and a fourth side surface SS4. The main surface B3A and the main surface B3B are planes substantially parallel to the X-Y plane. The main surface B3A opposes the main surface B2B of the base BA2.

The first side surface SS1 opposes a plurality of light emitting elements LD. The first side surface SS1 and the fourth side surface SS4 extend along the first direction X. The second side surface SS2 and the third side surface SS3 extend along the second direction Y. The first side surface SS1 and the fourth side surface SS4 oppose each other. The second side surface SS2 and the third side surface SS3 oppose each other. The second side surface SS2 and the third side surface SS3 intersect the first side surface SS1.

The base BA3 is adhered to the base BA2 while interposing the transparent layer LRI therebetween, as will be described later. In the example illustrated in FIG. 3, the first side surface SS1 is located directly above the end portion E21 of the substrate SUB2, but it may be located directly above the stretched region Ex or on a further outer side with respect to the end portion E11.

The transparent layer LRI is disposed on the main surface B3A. The transparent layer LRI has a refractive index n2 lower than the refractive index n1 of the base BA3. The transparent layer LRI comprises a plurality of band portions BND arranged to be spaced apart from each other. Each of the band portions BND extends along a predetermined direction. Between each adjacent pair of band portions BND, the main surface B3A is exposed. Further, the transparent layer LRI comprises a frame portion FRM which surrounds the plurality of band portions BND.

The region of the main surface B3A, which is occupied by the plurality of band portions BND overlaps the display area DA. Note that the shape of the transparent layer LRI will be described in detail later.

The base BA3 is formed, for example, of glass or an organic material such as polymethyl methacrylate (PMMA) or polycarbonate (PC). The transparent layer LRI is formed, for example, of an organic material such as siloxane-based resin or fluorine-based resin. Note that the refractive index n1 of the base BA3 is about 1.5, and the refractive index n2 of the transparent layer LRI is about 1.0 to 1.4.

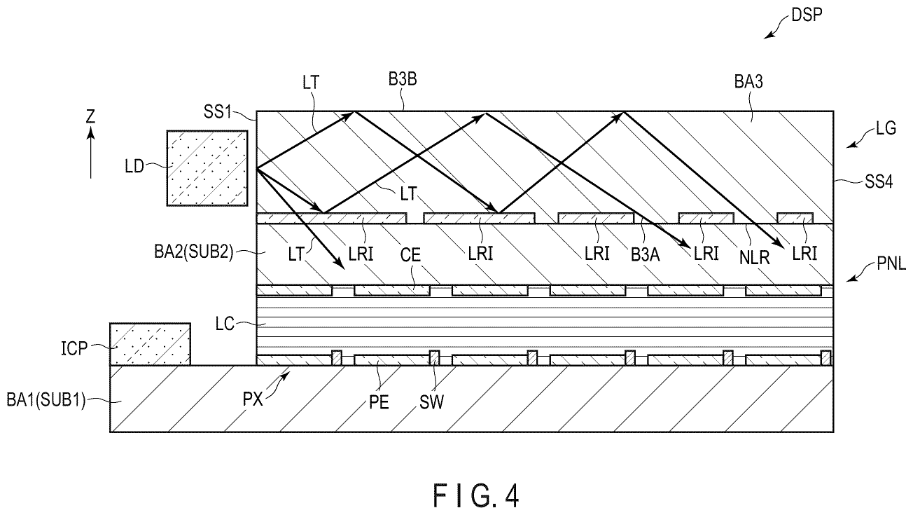

FIG. 4 is a cross-sectional view schematically showing an example of a configuration of the display device.

Light LT emitted from the light emitting elements LD enters the first side surface SS1 of the base BA3. The light LT entering the first side surface SS1 is guided inside the base BA3 by being reflected by the main surface B3B and the transparent layer LRI. The main surface B3B is the interface between the base BA3 and the air layer.

As described above, the light LT is reflected by the main surface B3B and the transparent layer LRI. But when it passes through a region NLR of the main surface B3A, where the transparent layer LRI is not provided, it enters the display panel PNL through the region NLR. Note that the light LT may as well enter the display panel PNL through the transparent layer LRI in some cases.

By being reflected at the transparent layer LRI, the light LT can be guided from the first side surface SS1, which is the incident surface, to the fourth side surface SS4, which opposes the first side surface SS1. The light LT entering the display panel PNL in the region NLR is diffused or transmitted by the liquid crystal layer LC of the display panel PNL. In this manner, images are displayed on the display device DSP.

The density of the transparent layer LRI is varied according to the distance from the light emitting elements LD. More specifically, as the location is closer to the light emitting elements LD, the area of the transparent layer LRI is larger. With this configuration, in a region closer to the light emitting elements LD, the amount of the light LT reflected by the transparent layer LRI is greater than the amount of the light LT entering the display panel PNL.

On the other hand, as discussed above, in a region far from the light emitting element LD, the area of the transparent layer LRI is smaller. With this configuration, in the region far from the light emitting elements LD, the amount of the light LT entering the display panel PNL is greater than the amount of the light LT reflected by the transparent layer LRI.

In order to achieve this, as shown in FIG. 3, it is preferable to provide the transparent layer LRI as triangular-shaped band portions BND. Here, the bottom edge of the triangle is placed in the region close to the light emitting elements LD, and the vertex of the triangle is placed in the region far from the light emitting elements LD.

With the above-described configuration, it is possible to guide the light LT to the region far from the light emitting element LD, and the brightness of the images displayed on the display device DSP can be made uniform.

However, as mentioned above, a new drawback has arisen, that is, moiré occurs between the transparent layer LRI and the pixels PX. The details will now be described with reference to the respective drawings.

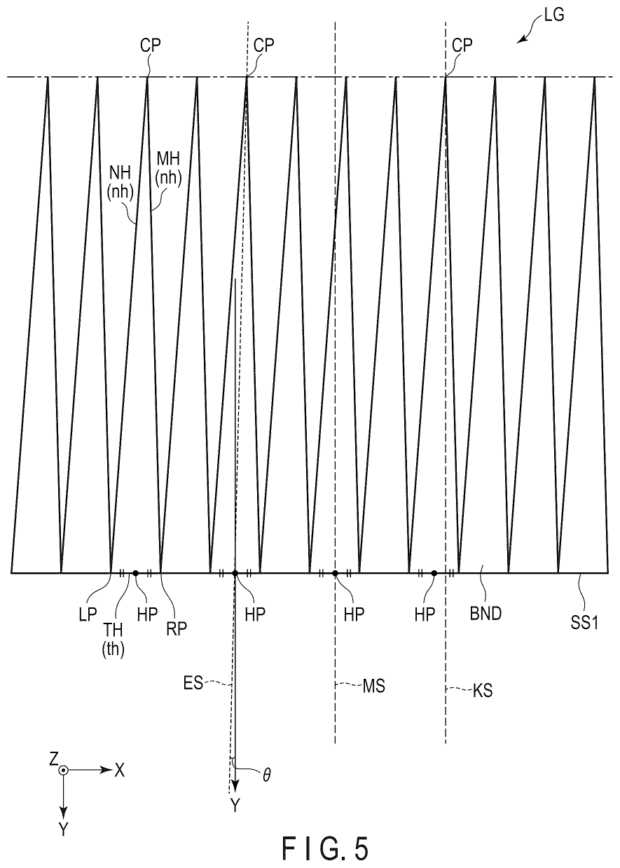

FIGS. 5 and 6 are each a plan view schematically showing an example of the configuration of the light guide element.

The transparent layer LRI provided in the light guide element LG comprises a plurality of band portions BND and a frame portion FRM surrounding the plurality of band portions BND, as described above. FIG. 5 shows only the band portions BND. FIG. 6 shows only a plurality of band portions BNDs, a plurality of pixels PX, a plurality of signal lines SL, and a plurality of scanning lines GL. In FIG. 6, the shaded area indicates a single pixel PX.

The shape of each of the plurality of band portions BND is a triangle. The triangular-shaped band portions BND each include a point LP, a point RP, and a point CP. The edge formed by the point LP and the point RP is defined as an edge TH. The edge formed by the point CP and the point LP is defined as an edge NH. The edge formed by the point CP and the point RP is defined as an edge MH. The point equidistant from the point LP and the point RP on the edge TH is defined as a point HP.

The plurality of band portions BND are arranged side by side along the first direction X. The edges TH of the plurality of band portions BND constitute a straight line extending along the first direction X. In FIG. 4, the straight line formed by the edges TH of the plurality of band portions BND coincides with the first side surface SS1. Note here that there may be a gap between the straight line formed by the edges TH of the band portions BNDs and the first side surface SS1.

The length of the edge NH is greater than the length of the edge MH. The length of the edge TH is less than the length of the edge NH or the edge MH. That is, if the lengths of the edge NH, the edge MH, and the edge TH are defined as a length nh, a length mh, and a length th, respectively, then a relationship: nh>mh>th is established.

As can be seen from the above description, the shape of each band BND is a triangle, but not an isosceles triangle. Here, the imaginary line connecting the point HP and the point CP is defined as an imaginary line ES. The direction of extension of the imaginary line ES is set as the direction of extension of the band portion BND. The direction of extension of the band portion BND is tilted at an angle θ with respect to the second direction Y.

The imaginary line MS passing through the point HP and extending along the second direction Y does not pass through the point CP. Further, the imaginary line KS passing through the point CP, which is the vertex, and extending along the second direction Y does not pass through the point HP.

Let us consider here the case where the direction of extension of the band portion BND is parallel to the second direction Y. Then, the direction of extension of the plurality of signal lines SL as well is parallel to the second direction Y. When the direction of extension of the band portions BND and the direction of extension of the signal lines SL are the same as each other, moiré will occur between a signal line SL and the respective band portion BND.

However, the band portions BND of the embodiment is tilted at an angle θ with respect to the second direction Y. With this configuration, no interference occurs between the band portion BND and the signal line SL, and therefore, moiré does not occur.

In this embodiment, it is preferable that the pitch of the band portions BND and that of the signal lines SL should be different from each other. This is because moiré tends to occur when the pitch of the band portions BND and the pitch of the signal lines SL are the same as each other.

In this embodiment, the pitch of the band portions BND corresponds to the length th of the edge TH. The pitch of the plurality of signal lines SL is the interval between each adjacent pair of signal lines SL.

In this embodiment, it is preferable that the pitch of the band portions BND is less than the pitch of the signal lines SL. The pitch of the band portions BND, that is, the length th of the edge TH should preferably be 133.2 μm, for example. On the other hand, the pitch of the plurality of signal lines SL (interval of each adjacent pair of signal lines SL) is, for example, 360 μm.

In this embodiment, the pitch of the band portions BND and that of the signal lines SL are also different, so the possibility of occurrence of moiré between the plurality of signal lines SL and the plurality of band portions BND is lower. Therefore, by making the direction and pitch in which the band portion BNDs are extended different from the direction and pitch in which the signal lines SL are extended, it is possible to suppress the occurrence of moiré.

Note that the plurality of scanning lines GL are arranged side by side at intervals of 360 μm along the second direction Y. In other words, the pitch of the plurality of scanning lines GL (interval between each adjacent pair of scanning lines GL) is the same as the pitch of the plurality of signal lines SL (interval between each adjacent pair of signal lines SL).

The influence by the interference between the scanning lines GL and the band portions BND is smaller than that of the interference between the signal lines SL and the band portions BND. The direction of extension of the scanning lines GL is parallel to the first direction X. The direction of extension of the straight line formed by the edges TH of the plurality of band portions BNDs is parallel to the first direction X. However, the edges TH of the band portions BND are present only in the vicinity of the first side surface SS1. With this configuration, moiré caused by the interference between the scanning lines GL and the band portions BND does not easily occur.

The region occupied by the plurality of band portions BND shown in FIGS. 5 and 6 overlaps the display area DA, as described above. Note that the region occupied by the band portions BND may be larger than the display area DA. In other words, the length of each of the plurality of band portions BND along the second direction Y is greater than or equal to the length of the display area DA along the second direction Y.

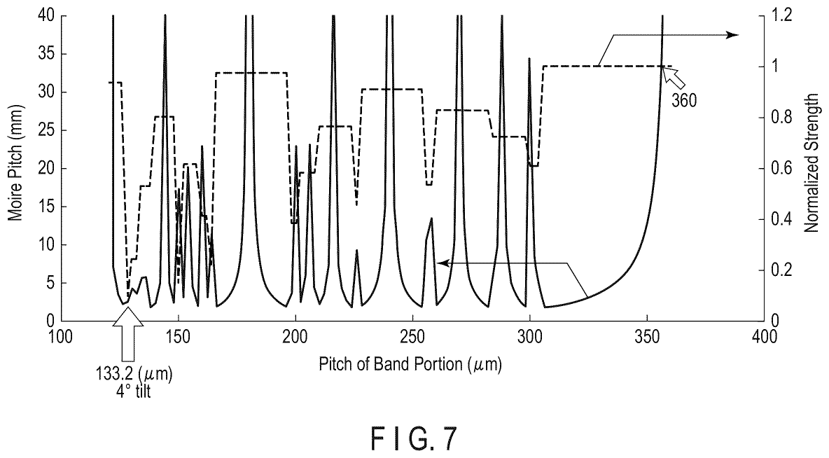

FIG. 7 shows the simulation results of the intensity and pitch of moiré when the pitch of the band portions is varied. As described above, the pitch of the band portions BND is equal to the length th of the edge TH. In the simulation shown in FIG. 7, the pitch of pixels PX, that is, the interval between each adjacent pair of signal lines SL and the interval between each adjacent pair of scanning lines GL are set to 360 μm, as described above. The direction of extension of the band portions BND is tilted by 4° with respect to the second direction Y (4° tilt), as shown in FIG. 5.

The horizontal axis in FIG. 7 indicates the pitch of the band portions BND (μm), the left vertical axis indicates the pitch of moiré (μm), and the right vertical axis indicates the normalized strength of moiré (Normalized Strength). In FIG. 7, the solid line indicates the pitch of moiré and the dotted line indicates the normalized strength of moiré.

Note that as the pitch of moiré (solid line) is closer to 0 μm, the moiré is less visible. Further, as the normalized intensity of moiré (dotted line) is closer to 0, the moiré is less visible. In FIG. 7, both the pitch of moiré (solid line) and the normalized intensity of moiré (dotted line) are close to 0 when the pitch of the band portions BND is 133.2 μm. Therefore, it is preferable to set the pitch for the band portions BND to 133.2 μm.

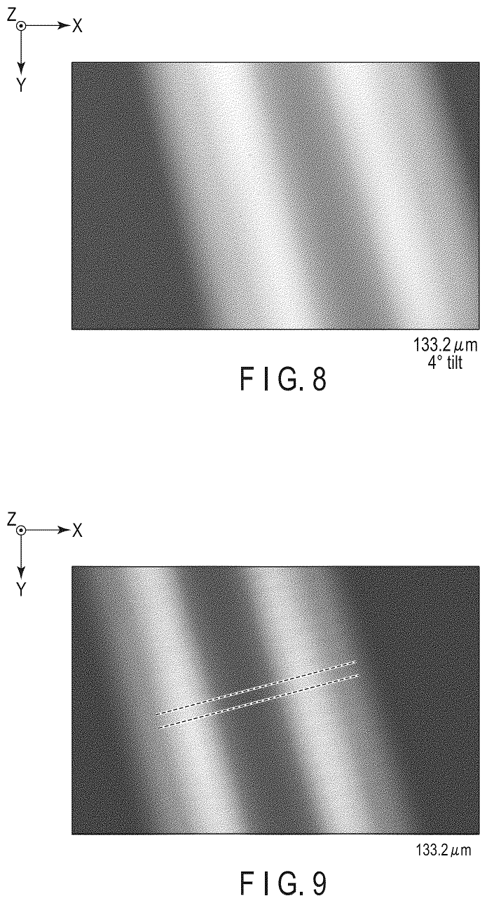

FIG. 8 is a diagram showing that moiré does not occur when the direction of extension of the band portions is tilted. FIG. 9 is a diagram showing that moiré occurs when the direction of extension of the band portions is not tilted. FIGS. 8 and 9 are photographs of the display device DSP as viewed from the upper surface, respectively.

In FIGS. 8 and 9, the pitch of the band portions BND is 133.2 μm in each case. In FIG. 8, the direction of extension of the band portions BND is tilted at 4° to the second direction Y. On the other hand, in FIG. 9, the direction of extension of the band portions BND is parallel to the second direction Y. In other words, the direction of extension of the band portion BND is not tilted with respect to the second direction Y.

Note that in FIG. 8, no moiré can be seen. On the other hand, in FIG. 9, a plurality of strips can be seen. In FIG. 9, to make the band portions more easily visible, two of the plurality of band portions are marked with dotted lines. From FIGS. 8 and 9, it can be understood that the occurrence of moiré can be suppressed by tilting the direction of extension of the band portions BND by 4° with respect to the second direction Y.

The fact that the direction of extension of the band portions BND is tilted at 4° with respect to the second direction Y means that the triangle formed by the band portion BND is not an isosceles triangle. FIG. 9 shows the case where the band portion BND is an isosceles triangle.

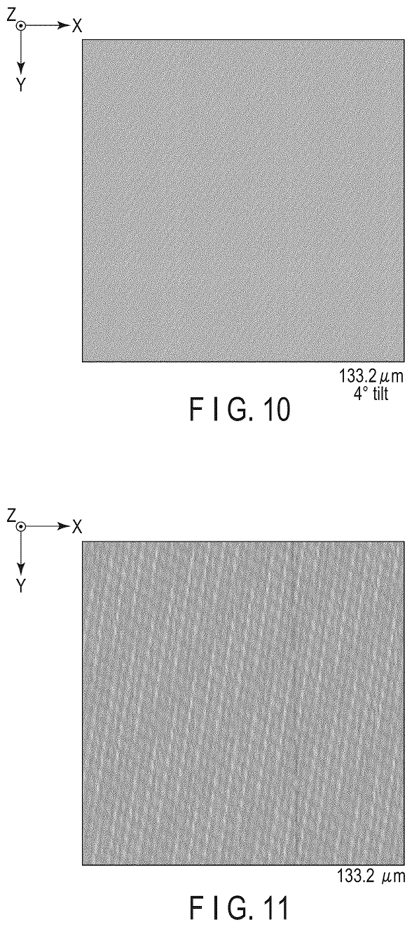

FIGS. 10 to 13 show simulation results of how moiré occurs when the pitch of the band portions is varied and when the direction of extension of the band portions is changed. In FIG. 10, the pitch of the band portions BND is 133.2 μm, and the direction of extension of the band portions BND is tilted 4° with respect to the second direction Y. In FIGS. 11, 12, and 13, the pitches of the band portions BND are 133.2 μm, 192 μm, and 360 μm, respectively. In FIGS. 11 to 13, the direction of extension of the band portions BND is parallel to the second direction Y.

As comparing FIG. 10 and FIG. 11 with each other, white bright spots or white strips are visually recognized in FIG. 11, but no such strips are observed in FIG. 10. In other words, FIG. 10 and FIG. 11 demonstrate that the occurrence of white strips (moiré) is suppressed when the direction of extension of the band portions BND is tilted with respect to the second direction Y.

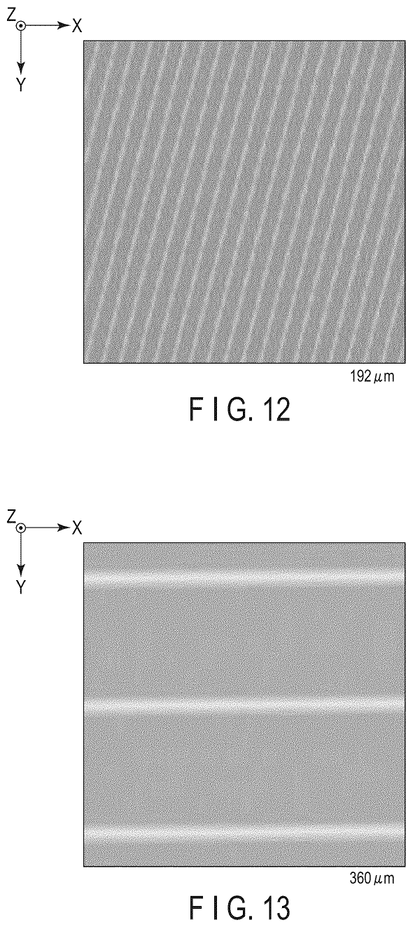

As comparing FIG. 11 to FIG. 13 with each other, wide strips are visually recognized in FIG. 13, extending in a direction approximately parallel to the first direction X. As comparing FIG. 11 and FIG. 12 with each other, white trips extending diagonally are formed at regular intervals in FIG. 12. The white strips shown in FIG. 12 are more clearly visible than the white strips in FIG. 11.

As shown in FIGS. 10 to 13, the occurrence of white strips (moiré) in FIG. 10 is suppressed more than those cases shown in FIGS. 11 to 13. In other words, it is demonstrated that when the pitch of the band portions BND of 133.2 μm or when and the direction of extension of the portion is tilted 4° from the second direction Y, it is more effective to suppress moiré.

The display device DSP of the embodiment comprises a display panel PNL and a light guiding element LG. The light guide element LG includes a transparent layer LRI having a low refractive index. The transparent layer LRI includes a plurality of band portions BND. Each of the plurality of band portions BNDs is formed in a triangular shape that is not an isosceles triangle.

The direction of extension of the imaginary line ES passing through the point HP, which is the center point of the edge TH, which is the bottom edge of the band portion BND and the point CP, which is the vertex of the band portion BND, is defined as the direction of extension of the band portions BND. Here, it is preferable that the direction of extension of the band portions BND should be tilted at 4° with respect to the second direction Y.

The direction of extension of the signal lines SL is parallel to the second direction Y. Therefore, it can be said that the direction of extension of the band portions BND is tilted 4° with respect to the direction of extension of the signal lines SL.

Note that the pitch of the band portions BND should preferably be different from the pitch of the signal lines SL. The pitch of the band portions BND should preferably be less than the pitch of the signal lines SL.

The pitch of the band portions BND is, for example, 133.2 μm. The pitch of the signal lines SL is, for example, 360 μm. The pitch of the scanning lines GL is, for example, 360 μm. Therefore, the pitch of the pixels PX in each of the first direction X and second direction Y is, for example, 360 μm.

With the band portions BND thus provided as described above, it is possible to suppress moiré generated between the band portions BND and the signal lines SL, in other words, between the band portions BND and the pixels PX. With this configuration, a display device DSP with improved display quality can be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a display panel comprising a first substrate, a second substrate, a liquid crystal layer containing a polymer dispersed liquid crystal;
a plurality of light emitting elements; and
a light guide element,
the first substrate comprising:
a first base;
a plurality of scanning lines provided on the first base, extending along a first direction and arranged along a second direction intersecting the first direction;
a plurality of signal lines provided on the first base, extend along the second direction, and arranged along the first direction;
a plurality of switching elements electrically connected to the plurality of scanning lines and the plurality of signal lines; and
a plurality of pixel electrodes electrically connected to the plurality of switching elements, respectively,
the second substrate comprising:
a second base; and
a common electrode opposing the plurality of pixel electrodes,
the light guide element comprising:
a third base; and
a transparent layer having a refractive index lower than a refractive index of the third base, wherein
the transparent layer includes a plurality of band portions arranged along the first direction,
each of the plurality of band portions includes a triangular shape having a first edge, a second edge, and a third edge,
the first side is shorter than the second edge and the third edge,
the second edge is shorter than the third edge,
the first edge extendes along the first direction,
a direction of extension of an imaginary line connecting a first point at a center of the first edge and a second point at which the second edge and the third edge intersect each other is set to a direction of extension of each of the plurality of band portions,
the direction of extension is tilted at an angle of 4° with respect to the second direction, and
a length of the first edge is shorter than an interval between each adjacent pair of the plurality of signal lines.

2. The display device according to claim 1, wherein
the length of the first edge is 133.2 μm, and
the interval between each adjacent pair of the plurality of signal lines is 360 μm.

3. The display device according to claim 1, wherein
the transparent layer is formed of a siloxane-based resin or a fluorine-based resin.

4. The display device according to claim 1, wherein
the refractive index of the third base is 1.5 and the refractive index of the transparent layer is 1.0 to 1.4.
